(19) United States
(12) Patent Application Publication
(10) Pub. No.: US 2026/0116354 A1
(43) Pub. Date: Apr. 30, 2026

(54) BRAKE SYSTEM FOR VEHICLES

(71) Applicant: HYUNDAI MOBIS CO., LTD., Seoul (KR)

(72) Inventor: Jae Hoon PI, Yongin-si (KR)

(73) Assignee: HYUNDAI MOBIS CO., LTD., Seoul (KR)

(21) Appl. No.: 19/346,998

(22) Filed: Oct. 1, 2025

(30) Foreign Application Priority Data
Oct. 29, 2024 (KR) 10-2024-0150117
Oct. 29, 2024 (KR) 10-2024-0150118

(51) Int. Cl. B60T 7/04; B60T 8/40

(52) U.S. Cl. CPC B60T 7/04; B60T 8/4081

(57) ABSTRACT

A brake system for vehicles includes a pedal configured to receive a pressing input from a user, a ball head connected to the pedal, an operating rod coupled to the ball head, and configured to move upon depression of the pedal, a backup piston configured to move inside a backup cylinder body according to movement of the operating rod, a bracket housing enclosing the backup piston, and a piston guard mounted to the bracket housing, and extending toward the operating rod, the piston guard contacting the operating rod so that foreign substances are prevented from entering the backup piston.

### CROSS-REFERENCE TO RELATED APPLICATION

This application claims priority from and the benefit of Korean Patent Application Nos. 10-2024-0150117 and 10-2024-0150118, filed on Oct. 29, 2024 and Oct. 29, 2024, respectively, which is hereby incorporated by reference for all purposes as if set forth herein.

### BACKGROUND

### Field

Exemplary embodiments of the present disclosure relate to a brake system for vehicles.

### Discussion of the Background

In general, due to the characteristics of electrically-powered brake systems for vehicles, a mechanism configured to convert a rotational motion of a motor into a linear motion of a piston in a cylinder to generate hydraulic brake pressure is required.

A ball screw device is applied to a brake system for vehicles as the mechanism for converting the rotational motion of the motor into the linear motion. The ball screw device includes a screw shaft that receives rotational force from the motor and rotates on an axis, a nut coupled to the screw shaft via balls and configured to move in an axial direction of the screw shaft, and a piston coupled to the nut and configured to pressurize a working fluid in the cylinder.

A conventional brake system for vehicles employs a bellows-type piston guard to prevent foreign substances from entering a backup piston. In the case of the bellows-type piston guard, an overall length thereof is restricted by a fixed installation length and a distance from a dash surface to a pedal assembly. Accordingly, in the case where the fixed installation length is relatively short and a full pedal stroke is relatively long, there is a design constraint.

Furthermore, in the conventional brake system for vehicles, dry friction occurs between the backup piston and a seal cup, thus causing stick-slip, sliding noise, and an inconsistent pedal feel.

The background art of the present disclosure is disclosed in Korean Patent Laid-open Publication No. 10-2021-0064367 (published on Jun. 2, 2021, entitled “Hydraulic Unit for Hydraulic Vehicle Brake System”).

### SUMMARY

Various embodiments are directed to providing a brake system for vehicles configured to prevent foreign substances from entering a backup piston.

Various embodiments are directed to providing a brake system for vehicles configured to facilitate upward and downward movement of a piston guard when the operating rod tilts, thereby improving sealing performance and sliding movability of an operating rod.

Various embodiments are directed to providing a brake system for vehicles configured to suppress the occurrence of dry friction between a backup piston and a seal cup.

A brake system for vehicles according to one embodiment of the present disclosure may include: a pedal configured to receive a pressing input from a user; a ball head connected to the pedal; an operating rod coupled to the ball head, and configured to move upon depression of the pedal; a backup piston configured to move inside a backup cylinder according to movement of the operating rod; a bracket housing enclosing the backup piston; and a piston guard mounted to the bracket housing, and extending toward the operating rod, the piston guard contacting the operating rod so that foreign substances are prevented from entering the backup piston.

The piston guard may include: a guard mounting portion mounted to the bracket housing; and a guard blocking portion integrally formed with the guard mounting portion, and extending toward the operating rod, the guard blocking portion contacting the operating rod.

The guard mounting portion may include: a peripheral mounting portion enclosing the bracket housing; and a peripheral extension portion extending from the peripheral mounting portion toward the pedal, and enclosing the operating rod. A connection groove may be formed in an inner surface of the guard mounting portion where the peripheral mounting portion and the peripheral extension portion are connected.

The connection groove may be continuously formed in a circumferential direction on the inner surface of the guard mounting portion.

An angle formed between the guard mounting portion and the guard blocking portion may be an acute angle.

The guard blocking portion may include: a connection blocking portion coupled to the guard mounting portion; and a contact blocking portion extending from the connection blocking portion, and having a length greater than a distance from an end of the connection blocking portion to the operating rod, the contact blocking portion contacting the operating rod.

A thickness of the connection blocking portion may be greater than a thickness of the contact blocking portion.

The piston guard may include a rubber material.

A brake system for vehicles according to another embodiment of the present disclosure may include: a backup cylinder body; a backup piston located in the backup cylinder body, and configured to be movable upon depression of a pedal; a pedal simulator piston movably disposed in the backup cylinder body, and spaced apart from the backup piston; a first backup chamber defined in the backup cylinder body between the backup piston and the pedal simulator piston, and configured to store first brake fluid; a stopper disposed in the backup cylinder body, and configured to restrict movement of the pedal simulator piston; a second backup chamber defined in the backup cylinder body between the stopper and the pedal simulator piston, and spaced apart from the first backup chamber, the second backup chamber being configured to store brake fluid; a first seal cup disposed on an inner wall of the backup cylinder body, and configured to contact the backup piston, the first seal cup being spaced apart from a first port connected to a reservoir toward the pedal; and a grease pocket spaced apart from the first seal cup toward the pedal, the grease pocket being formed in a recessed groove shape and configured to be filled with grease.

The grease pocket may be formed in a circumferential direction along the inner wall of the backup cylinder body.

The first seal cup may include a filling groove in an inner surface thereof that comes into contact with the backup piston, the filling groove being configured to be filled with grease.

The filling groove may be formed along a circumferential direction in the inner surface of the first seal cup.

The filling groove may include a plurality of filling grooves formed in the inner surface of the first seal cup.

The plurality of filling grooves may be arranged at regular intervals on the inner surface of the first seal cup.

### BRIEF DESCRIPTION OF THE DRAWINGS

FIG. 1 is a hydraulic circuit diagram illustrating a brake system for vehicles according to an embodiment of the present disclosure.

FIG. 2 is a sectional view illustrating a backup master cylinder unit according to an embodiment of the present disclosure.

FIG. 3 is an enlarged view of portion A in FIG. 2.

FIG. 4 is a perspective view illustrating a first seal cup according to an embodiment of the present disclosure.

FIG. 5 is a sectional view illustrating the first seal cup according to an embodiment of the present disclosure.

FIG. 6 is a sectional perspective view illustrating the first seal cup according to an embodiment of the present disclosure.

FIG. 7 is an enlarged view of portion B of FIG. 2.

FIG. 8 is an exploded perspective view illustrating portion B of FIG. 2.

FIG. 9 is a view illustrating a surrounding portion of a piston guard according to an embodiment of the present disclosure.

FIG. 10 is an enlarged view of portion C of FIG. 9.

FIG. 11 is a perspective view illustrating a damper according to an embodiment of the present disclosure.

FIG. 12 is a front view illustrating the damper according to an embodiment of the present disclosure.

FIG. 13 is a sectional view taken along line B-B of FIG. 11.

FIG. 14 is a sectional view taken along line C-C of FIG. 11.

FIG. 15 is a sectional view taken along line D-D of FIG. 11.

FIG. 16 is a view illustrating deformation states A to E of the damper by a stopper and a pedal simulator piston according to an embodiment of the present disclosure.

FIG. 17 is a displacement-force graph illustrating states A to E shown in FIG. 16.

### DETAILED DESCRIPTION

Hereinafter, embodiments of a brake system for vehicles according to the present disclosure will be described with reference to the accompanying drawings. It should be noted that the drawings are not to precise scale and may be exaggerated in thickness of lines or sizes of components for descriptive convenience and clarity only. Furthermore, the terms as used herein are defined by taking functions of the present disclosure into account and can be changed according to the custom or intention of users or operators. Therefore, definition of the terms should be made according to the overall disclosures set forth herein.

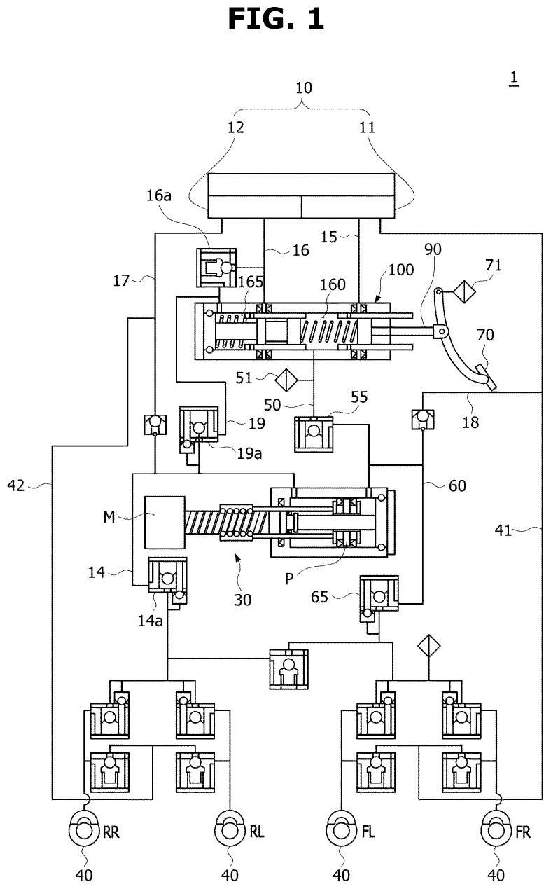

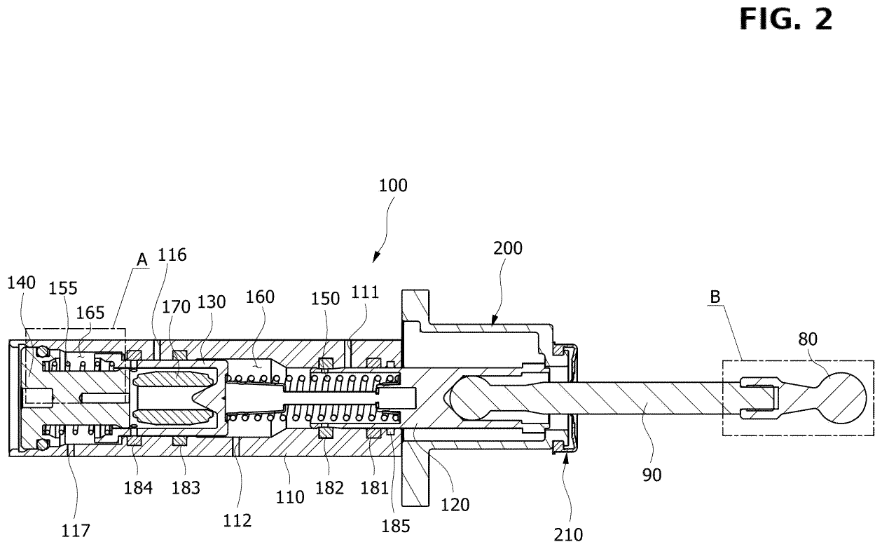

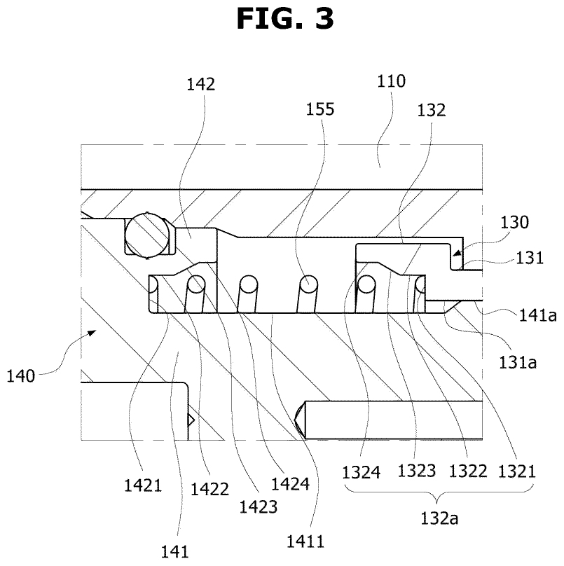

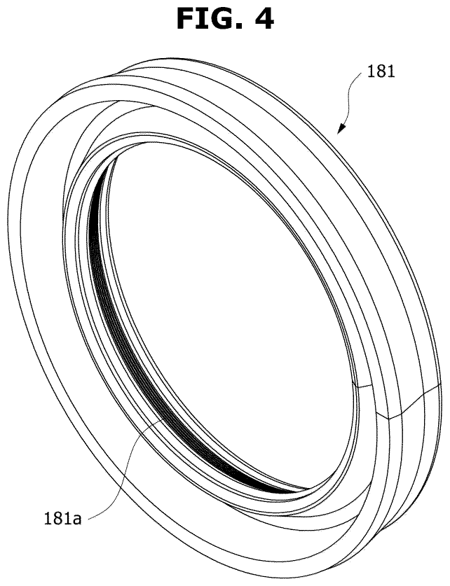

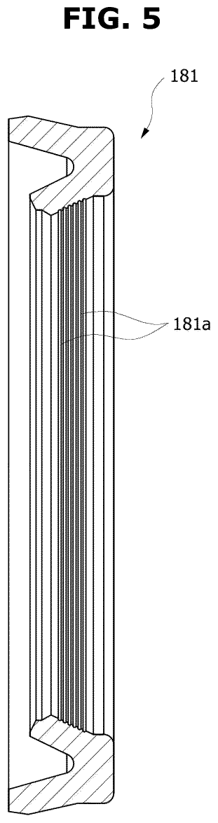

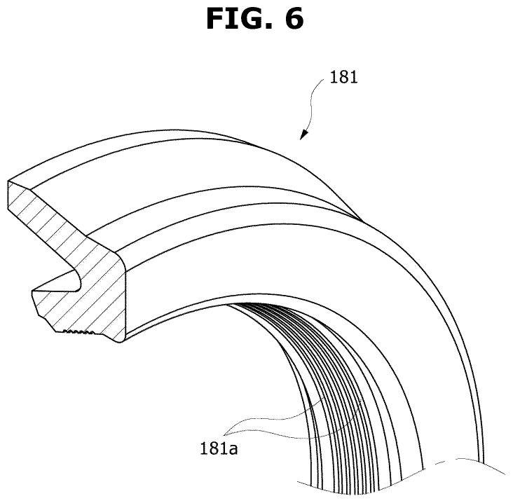

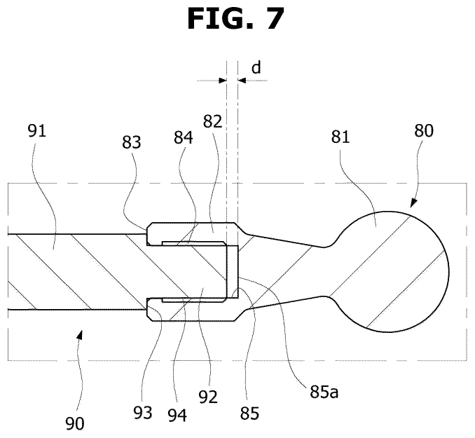

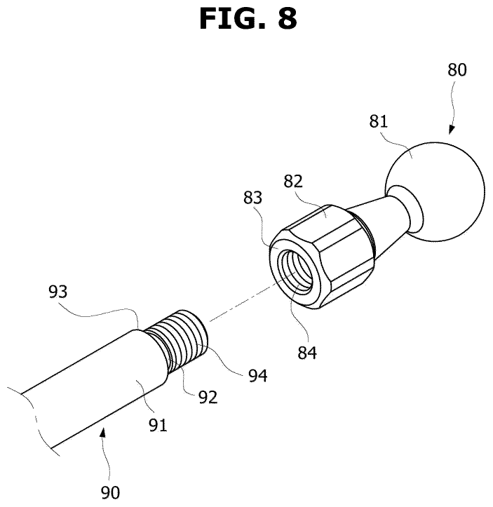

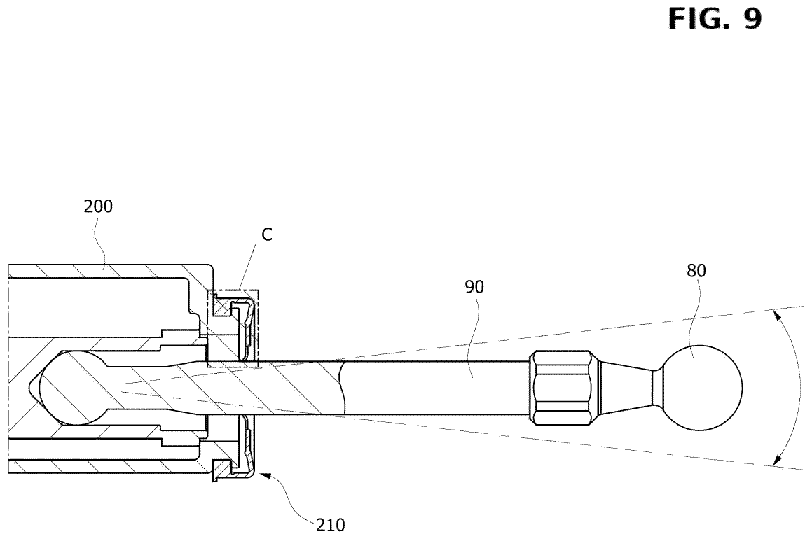

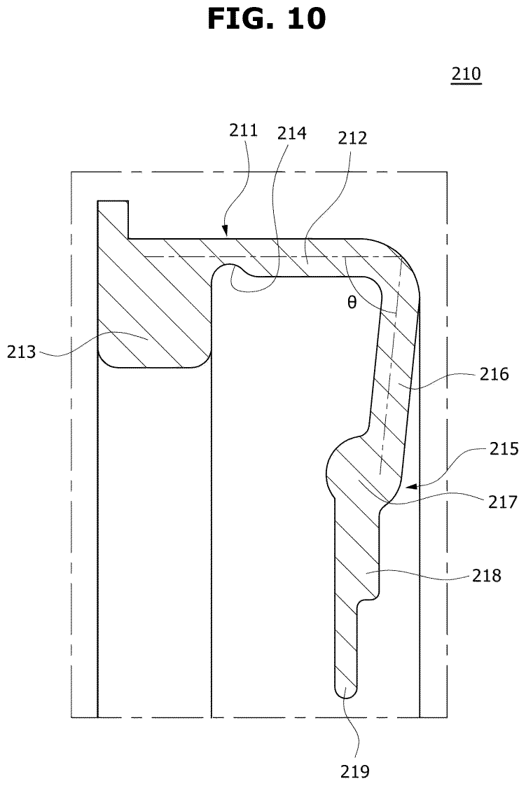

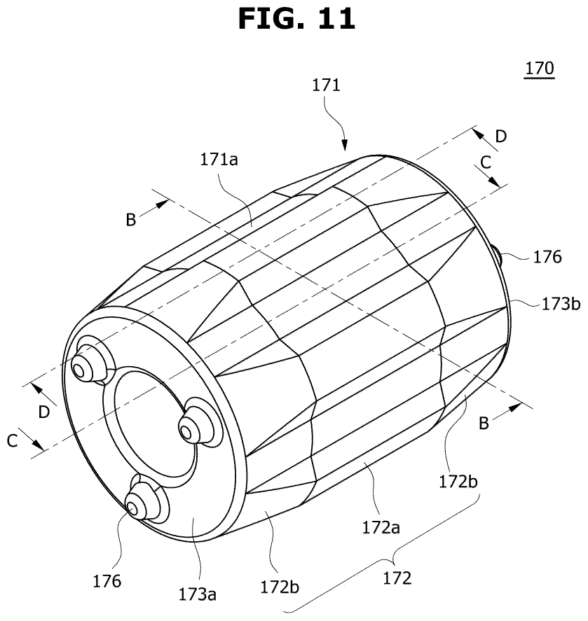

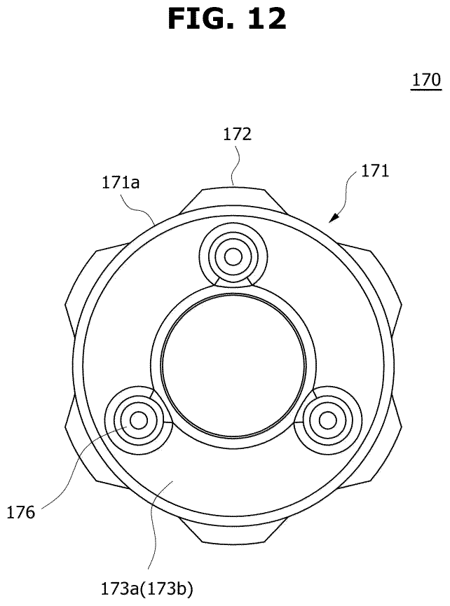

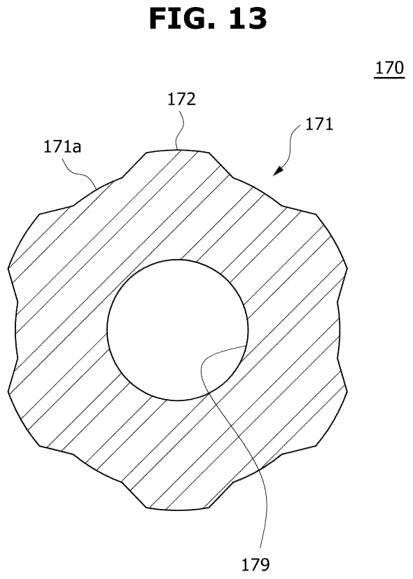

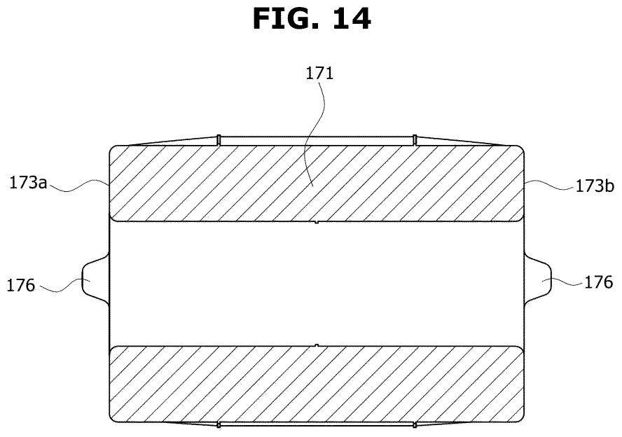

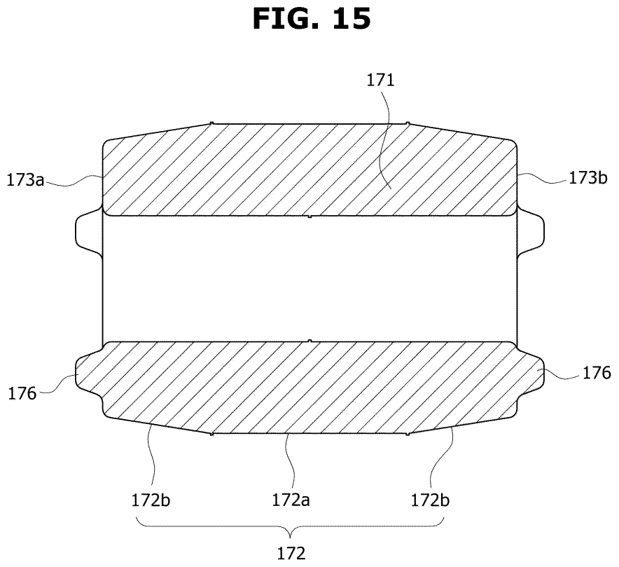

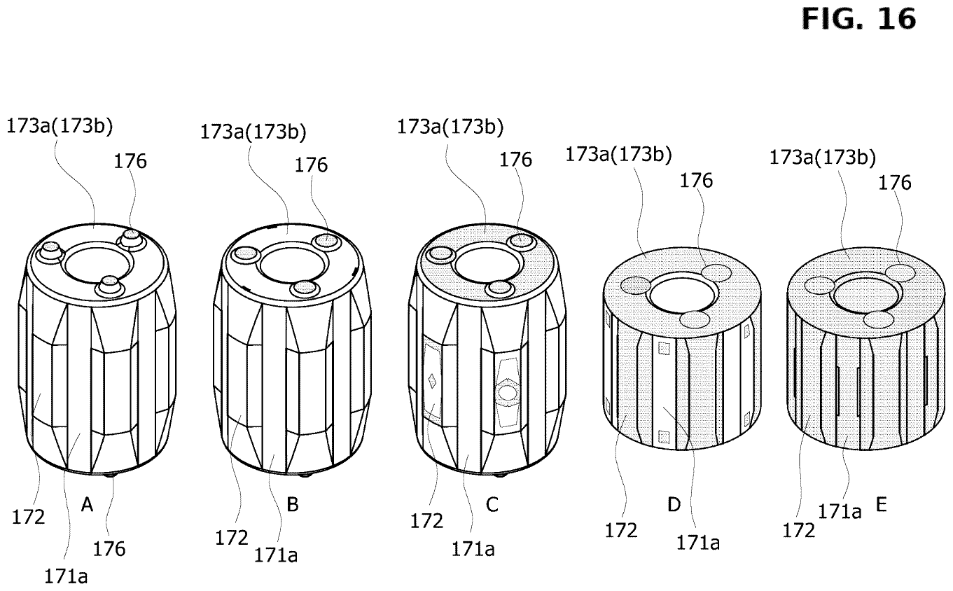

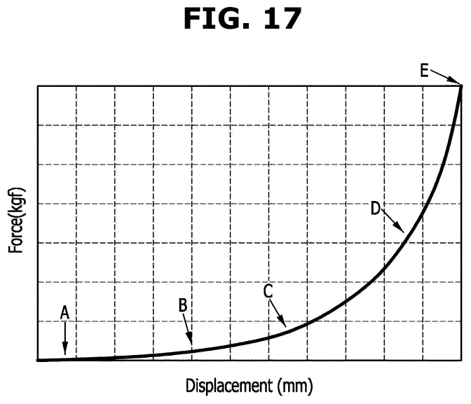

FIG. 1 is a hydraulic circuit diagram illustrating a brake system for vehicles according to an embodiment of the present disclosure. FIG. 2 is a sectional view illustrating a backup master cylinder unit according to an embodiment of the present disclosure. FIG. 3 is an enlarged view of portion A in FIG. 2. FIG. 4 is a perspective view illustrating a first seal cup according to an embodiment of the present disclosure. FIG. 5 is a sectional view illustrating the first seal cup according to an embodiment of the present disclosure. FIG. 6 is a sectional perspective view illustrating the first seal cup according to an embodiment of the present disclosure. FIG. 7 is an enlarged view of portion B of FIG. 2. FIG. 8 is an exploded perspective view illustrating portion B of FIG. 2. FIG. 9 is a view illustrating a surrounding portion of a piston guard according to an embodiment of the present disclosure. FIG. 10 is an enlarged view of portion C of FIG. 9. FIG. 11 is a perspective view illustrating a damper according to an embodiment of the present disclosure. FIG. 12 is a front view illustrating the damper according to an embodiment of the present disclosure. FIG. 13 is a sectional view taken along line B-B of FIG. 11. FIG. 14 is a sectional view taken along line C-C of FIG. 11. FIG. 15 is a sectional view taken along line D-D of FIG. 11. FIG. 16 is a view illustrating deformation states A to E of the damper by a stopper and a pedal simulator piston according to an embodiment of the present disclosure. FIG. 17 is a displacement-force graph illustrating the states A to E shown in FIG. 16.

Referring to FIGS. 1 and 2, a brake system 1 for vehicles according to an embodiment of the present disclosure may include a reservoir 10, a backup master cylinder unit 100, a main master cylinder unit 30, a motor M, a first flow path 50, a first valve 55, a second flow path 60, a second valve 65, and a pedal 70.

The reservoir 10 may store brake fluid. The reservoir 10 may be sectioned into a first storage portion 11 and a second storage portion 12. The reservoir 10 may be connected to the backup master cylinder unit 100 to supply brake fluid to the backup master cylinder unit 100.

The brake fluid discharged from the reservoir 10 may flow toward and be supplied to a plurality of wheel cylinders 40, thereby satisfying required braking force. The reservoir 10 is connected to the wheel cylinders 40 to recover the brake fluid.

The backup master cylinder unit 100 is located between the reservoir 10 and the wheel cylinders 40. The backup master cylinder unit 100 is connected to the reservoir 10, and may generate hydraulic pressure by pressing of the pedal 70. The backup master cylinder unit 100 may include the pedal 70, a pedal stroke sensor 71, an operating rod 90, and a backup cylinder body 110.

The pedal 70 is a component that is pressed by a driver to perform braking. The pedal stroke sensor 71 provided on the pedal 70 may sense a stroke of the pedal 70. The operating rod 90 may interlock with depression of the pedal 70 and pressurize an interior of the backup cylinder body 110.

The backup cylinder body 110 may include a first backup chamber 160 and a second backup chamber 165 each of which stores the brake fluid. The first backup chamber 160 and the second backup chamber 165 are not in communication with each other.

Through an open end of the first backup chamber 160 (a right end based on FIG. 2), the operating rod 90 and a backup piston 120 connected to an end of the operating rod 90 (a left end based on FIG. 2) may be inserted into the backup cylinder body 110.

When the user, that is, the driver, depresses the pedal 70, in other words, steps on the pedal 70, the operating rod 90 and the backup piston 120 may move forward (to the left based on FIG. 2) in the first backup chamber 160, thus pressurizing the brake fluid.

As the first backup chamber 160 is pressurized, the brake fluid in the second backup chamber 165 may also be pressurized. A stopper 140 may be disposed at an end of the second backup chamber 165 (a left end based on FIG. 2), and movement of a pedal simulator piston 130 installed inside the second backup chamber 165 may be restricted to provide pedal feel to the driver.

A first backup flow path 15 is connected at an end thereof to the first storage portion 11 and at a remaining end thereof to the first backup chamber 160. The brake fluid discharged from the first storage portion 11 may be supplied to the first backup chamber 160 through the first backup flow path 15.

A second backup flow path 16 is connected at an end thereof to the second storage portion 12 and at a remaining end thereof to the second backup chamber 165. The brake fluid discharged from the second storage portion 12 may be supplied to the second backup chamber 165 through the second backup flow path 16.

A first backup valve 16a may be disposed on the second backup flow path 16. The first backup valve 16a may be of a normally closed type and may remain in a closed state in a non-powered mode. More specifically, the first backup valve 16a may block the brake fluid from flowing from the reservoir 10 to the second backup chamber 165.

The main master cylinder unit 30 is configured such that hydraulic pressure of the brake fluid is adjusted by a piston P that is moved by driving the motor M, thus generating required braking force. A plurality of main chambers in which the brake fluid is stored may be provided inside the main master cylinder unit 30.

The main master cylinder unit 30 may be connected to the plurality of wheel cylinders 40, and may supply the brake fluid to the wheel cylinders 40. The wheel cylinders 40 to which the brake fluid is supplied may provide braking force to vehicle wheels.

In the case where the main master cylinder unit 30 normally operates, the brake fluid pressurized by the motor M may be supplied to the wheel cylinders 40. In the case where the main master cylinder unit 30 malfunctions, the brake fluid pressurized by pressing of the pedal 70 may be supplied to the wheel cylinders 40.

The third backup flow path 17 is connected at an end thereof to the second storage portion 12 and at a remaining end thereof to the main flow path 14. The flow of the brake fluid discharged from the second storage portion 12 may be controlled by a control valve 14a.

At least one check valve may be disposed on the third backup flow path 17. The check valve may block the brake fluid from flowing backward from the main chambers of the main master cylinder unit 30 to the second storage portion 12.

The fourth backup flow path 18 may be connected at an end thereof to a point on a first recovery flow path 41 and at a remaining end thereof to the main chambers of the main master cylinder unit 30. The first recovery flow path 41 is connected to the first storage portion 11. Accordingly, the brake fluid discharged from the wheel cylinders 40 may be recovered to the reservoir 10.

At least one check valve may be disposed on the fourth backup flow path 18. The check valve may block the brake fluid from flowing backward from the main chambers of the main master cylinder unit 30 to the first recovery flow path 41.

The second recovery flow path 42 is connected to the second storage portion 12. Therefore, the brake fluid discharged from the wheel cylinders 40 may be recovered to the reservoir 10.

The fifth backup flow path 19 may be connected at an end thereof to a point on the second backup flow path 16 and at a remaining end thereof to a point on the main flow path 14. A second backup valve 19a may be disposed on the fifth backup flow path 19. The second backup valve 19a may be of a normally open type.

The main flow path 14 may be connected to the main master cylinder unit 30. The brake fluid discharged from the main master cylinder unit 30 may flow through the main flow path 14. The wheel cylinders 40 may receive the brake fluid from the main master cylinder unit 30 through the main flow path 14.

The control valve 14a configured to open and close the main flow path 14 may be disposed at a point on the main flow path 14. The control valve 14a may be of a normally open type. Accordingly, the control valve 14a may be open in the non-powered mode.

The first flow path 50 connects the backup master cylinder unit 100 and the main master cylinder unit 30. The brake fluid may flow through the first flow path 50. The first flow path 50 is connected at an end thereof to the first backup chamber 160 and at a remaining end thereof to a first main chamber (reference numeral omitted) of the main master cylinder unit 30.

A hydraulic pressure sensor 51 may be provided on the first flow path 50. The hydraulic pressure sensor 51 may be disposed on the first flow path 50 between the first backup chamber 160 and the first valve 55. The hydraulic pressure sensor 51 may sense hydraulic pressure of the brake fluid generated by the backup master cylinder unit 100.

The first valve 55 may be located on the first flow path 50, and may control the flow of the brake fluid. The first valve 55 may be of a normally open type.

The second flow path 60 may be connected to the main master cylinder unit 30. The brake fluid discharged from the main master cylinder unit 30 may flow through the second flow path 60. The second flow path 60 is connected to the first main chamber of the main master cylinder unit 30. Accordingly, the wheel cylinders 40 may receive the brake fluid from the main master cylinder unit 30 through the second flow path 60.

The second valve 65 may be located on the second flow path 60, and may control the flow of brake fluid. The second valve 65 is disposed at a point on the second flow path 60 to open and close the second flow path 60. The second valve 65 may be of a normally open type. Accordingly, the second valve 65 is open in a non-powered mode. In the case where the second valve 65 is closed, the flow of the brake fluid through the second flow path 60 may be blocked.

A controller (not shown) may control operations of the first valve 55 and the first backup valve 16a. When the driver depresses the pedal 70, the controller may provide pedal feel corresponding to the depression of the pedal 70 by controlling the first valve 55 and the first backup valve 16a. Accordingly, the pedal reaction force may be simulated according to the present disclosure.

In the case where the brake system operates normally, when the pedal 70 is pressed during vehicle travel, the main master cylinder unit 30 may be driven in response to a pedal pressing degree sensed by the backup master cylinder unit 100. The brake fluid pressurized by the main master cylinder unit 30 is supplied to the wheel cylinders 40, thus implementing braking of the vehicle.

The first valve 55 may be a normally open valve. In the case where the brake system is normal, power may be supplied to the first valve 55 to block the brake fluid from flowing from the first flow path 50 to the second flow path 60.

In the case where the brake system operates abnormally, no power is supplied to the first valve 55, causing the flow path to open, thereby connecting the first flow path 50 and the second flow path 60. In this state, if the pedal 70 is pressed while the vehicle travels, the brake fluid pressurized by the backup master cylinder unit 100 passes through the first flow path 50 and the second flow path 60, and is then supplied to the wheel cylinders 40, thus braking the vehicle.

Referring to FIGS. 1 to 3, the backup master cylinder unit 100 according to an embodiment of the present disclosure may include the backup cylinder body 110, the backup piston 120, the pedal simulator piston 130, the stopper 140, the first backup chamber 160, and the second backup chamber 165.

The backup piston 120 is disposed inside the backup cylinder body 110, and is movable forward or backward (a left or right direction based on FIG. 2) within the backup cylinder body 110 depending on whether the pedal 70 is pressed or released. As the driver presses the pedal 70, the backup piston 120 may move forward (to the left based on FIG. 2) inside the backup cylinder body 110.

The pedal simulator piston 130 is movable forward or backward inside the backup cylinder body 110, and may be located to be spaced apart from the backup piston 120. In conjunction with the forward movement of the backup piston 120, the pedal simulator piston 130 may also move forward.

The stopper 140 may be disposed inside the backup cylinder body 110, and may limit the movement of the pedal simulator piston 130. When the pedal simulator piston 130 moving forward comes into contact with the stopper 140, further forward movement of the pedal simulator piston 130 may be blocked.

The first backup chamber 160 is defined inside the backup cylinder body 110 by an inner wall of the backup cylinder body 110, the backup piston 120, and the pedal simulator piston 130. The first backup chamber 160 may store the brake fluid supplied from the first storage portion 11.

The second backup chamber 165 is defined inside the backup cylinder body 110 by the inner wall of the backup cylinder body 110, the stopper 140, and the pedal simulator piston 130. The second backup chamber 165 may store the brake fluid supplied from the second storage portion 12.

The backup master cylinder unit 100 according to an embodiment of the present disclosure may include a first spring 150 and a second spring 155.

The first spring 150 may be disposed in the first backup chamber 160, and may elastically support the backup piston 120 and the pedal simulator piston 130.

A first side (a right side based on FIG. 2) of the first spring 150 is connected to or supported by the backup piston 120, and a second side (a left side based on FIG. 2) of the first spring 150 is connected to or supported by the pedal simulator piston 130, so that the first spring 150 may be compressed and deformed by forward movement of the backup piston 120. When the pressing of the pedal 70 is released, the backup piston 120 may return to an original position thereof by the elastic restoring force of the first spring 150.

The second spring 155 is disposed in the second backup chamber 165. The second spring 155 may be located between the stopper 140 and the pedal simulator piston 130, and may elastically support the pedal simulator piston 130.

A first side (a right side based on FIG. 2) of the second spring 155 is connected to or supported by the pedal simulator piston 130, and a second side (a left side based on FIG. 2) of the second spring 155 is connected to or supported by the stopper 140, so that the second spring 155 may be compressed and deformed by forward movement of the pedal simulator piston 130. When the pressing of the pedal 70 ends, the pedal simulator piston 130 may return to an original position thereof by the elastic restoring force of the second spring 155.

The pedal simulator piston 130 may include a pedal simulator piston body 131 and a piston extension 132.

The pedal simulator piston body 131 has a columnar shape that is closed at a first side (a right side based on FIG. 2) and open at a second side (a left side based on FIG. 2). The stopper 140 may be disposed so as to be inserted into an open end (a left end based on FIG. 2) of the pedal simulator piston body 131.

The pedal simulator piston body 131 may include a space to allow the damper 170 to be disposed therein. The damper 170 is enclosed by the pedal simulator piston body 131 and the stopper 140.

Due to the first spring 150, the second spring 155, and the damper 170, a predetermined reaction force may be provided to the driver when the pedal 70 is pressed, and a restoring force may be provided to the pedal 70 when pressing of the pedal 70 is released.

The pedal simulator piston extension 132 is connected to the open end (the left end based on FIG. 2) of the pedal simulator piston body 131 and is formed to enclose the stopper 140. The pedal simulator piston extension 132 may be integrally formed with the pedal simulator piston body 131.

An inner diameter of the pedal simulator piston extension 132 is greater than an inner diameter of the pedal simulator piston body 131. In other words, a diameter of an inner diameter portion 132a of the pedal simulator piston extension 132 is greater than a diameter of an inner diameter portion 131a of the pedal simulator piston body 131. Accordingly, the pedal simulator piston extension 132 has a larger space at the inner diameter portion 132a than the pedal simulator piston body 131.

The second spring 155 is disposed between the stopper 140 and the pedal simulator piston 130, and may be positioned at the inner diameter portion 132a of the pedal simulator piston extension 132.

The inner diameter portion 132a of the pedal simulator piston extension 132 may include a seating stepped portion 1321 and a first diameter-enlarged portion 1322.

The seating stepped portion 1321 is connected to the inner diameter portion 131a of the pedal simulator piston body 131. The pedal simulator piston extension 132 may have a larger internal space than the pedal simulator piston body 131 by a length of the seating stepped portion 1321. The second spring 155 is seated on the seating stepped portion 1321.

The first diameter-enlarged portion 1322 is connected to the seating stepped portion 1321 and encloses the second spring 155. The first diameter-enlarged portion 1322 has a larger inner diameter than the inner diameter portion 131a of the pedal simulator piston body 131.

Because the second spring 155 is positioned at the inner diameter portion 132a of the pedal simulator piston extension 132, in other words, because the pedal simulator piston extension 132 encloses the second spring 155, movement of the second spring 155 during compression of the second spring 155 may be restricted by the pedal simulator piston extension 132.

The inner diameter portion 132a of the pedal simulator piston extension 132 may include a second diameter-enlarged portion 1324. The second diameter-enlarged portion 1324 has a larger inner diameter than the first diameter-enlarged portion 1322 and encloses the second spring 155.

Even if buckling of the second spring 155, particularly outward buckling (upward based on FIG. 3), occurs during compression of the second spring 155, the second spring 155 does not come into contact with the second diameter-enlarged portion 1324 because the second diameter-enlarged portion 1324 is positioned farther outward than the first diameter-enlarged portion 1322. Accordingly, the second spring 155 may be prevented from interfering with the pedal simulator piston 130 during compression of the second spring 155, thus avoiding operational loss.

The inner diameter portion 132a of the pedal simulator piston extension 132 may include a transition portion 1323. The transition portion 1323 connects the first diameter-enlarged portion 1322 and the second diameter-enlarged portion 1324, and gradually increases in inner diameter from the first diameter-enlarged portion 1322 toward the second diameter-enlarged portion 1324. The transition portion 1323 may be formed in an inclined surface shape.

Because the inner diameter portion 132a of the pedal simulator piston extension 132 is gradually enlarged in inner diameter from the first diameter-enlarged portion 1322 to the second diameter-enlarged portion 1324 by the transition portion 1323, the second spring 155 may be prevented from being damaged even when the second spring 155 comes into contact with the inner diameter portion 132a of the pedal simulator piston extension 132 due to buckling deformation of the second spring 155.

The stopper 140 may include a stopper body 141 and a stopper protrusion 142.

The stopper body 141 has a columnar shape extending in a longitudinal direction of the backup cylinder body 110. A first end (a right end based on FIG. 2) of the stopper body 141 may be inserted into the open end of the pedal simulator piston body 131.

The stopper body 141 may be disposed inside the second spring 155. That is, the stopper body 141 is enclosed by the second spring 155.

The stopper protrusion 142 is connected to a second end (a left end based on FIG. 2) of the stopper body 141 and protrudes outward from the stopper body 141. A portion of the stopper protrusion 142 is disposed to face an outer circumferential surface of the stopper body 141 and encloses the second spring 155.

The stopper protrusion 142 may include a stopper stepped portion 1421 and a first stopper protrusion 1422.

The stopper stepped portion 1421 is connected to the stopper body 141. The first stopper protrusion 1422 may provide a larger internal space by an amount by which the stopper stepped portion 1421 extends outward. The second spring 155 is seated on the stopper stepped portion 1421. An outer diameter portion 141a of the stopper body 141 may come into contact with the inner diameter portion 131a of the pedal simulator piston body 131.

The first stopper protrusion 1422 is connected to the stopper stepped portion 1421, and encloses the second spring 155. An inner diameter of the first stopper protrusion 1422 is greater than a diameter of the outer diameter portion 141a of the stopper body 141.

Because the second spring 155 is disposed at an inner diameter portion of the first stopper protrusion 1422, in other words, because the first stopper protrusion 1422 encloses the second spring 155, movement of the second spring 155 during compression of the second spring 155 may be restricted by the first stopper protrusion 1422.

The stopper protrusion 142 may include a second stopper protrusion 1424. The second stopper protrusion 1424 has a larger inner diameter than the first stopper protrusion 1422 and encloses the second spring 155.

Even if buckling of the second spring 155, particularly outward buckling (upward based on FIG. 3), occurs during compression of the second spring 155, the second spring 155 does not come into contact with the second stopper protrusion 1424 because the second stopper protrusion 1424 is positioned farther outward than the first stopper protrusion 1422. Accordingly, the second spring 155 may be prevented from interfering with the stopper protrusion 142 during compression of the second spring 155, thus avoiding operational loss.

The stopper protrusion 142 may include a stopper transition portion 1423. The stopper transition portion 1423 connects the first stopper protrusion 1422 and the second stopper protrusion 1424, and gradually increases in inner diameter from the first stopper protrusion 1422 toward the second stopper protrusion 1424. The stopper transition portion 1423 may be formed in an inclined surface shape.

Because an inner diameter portion of the stopper protrusion 142 is gradually enlarged in inner diameter from the first stopper protrusion 1422 to the second stopper protrusion 1424 by the stopper transition portion 1423, the second spring 155 may be prevented from being damaged even when the second spring 155 comes into contact with the inner diameter portion of the stopper protrusion 142 due to buckling deformation of the second spring 155.

An interference-prevention recess 1411 may be formed in the stopper body 141. The interference-prevention recess 1411 may be formed in an outer circumferential surface of the stopper body 141, and may be located in a region enclosed by the second spring 155. Since the interference-prevention recess 1411 is recessed inward in the outer circumferential surface of the stopper body 141, a gap between the second spring 155 and the region corresponding to the interference-prevention recess 1411 becomes greater than that of other regions of the stopper body 141.

Even if buckling of the second spring 155, particularly inward buckling (downward based on FIG. 3), occurs during compression of the second spring 155, the region of the stopper body 141 where the interference-prevention recess 1411 is formed is spaced farther apart from the second spring 155 compared to other regions of the stopper body 141, so that the second spring 155 does not come into contact with the region corresponding to the interference-prevention recess 1411. Accordingly, interference between the second spring 155 and the stopper body 141 during compression of the second spring 155 may be prevented, thereby avoiding operational loss.

The second spring 155 may be seated on both the seating stepped portion 1321 of the pedal simulator piston extension 132 and the stopper stepped portion 1421 of the stopper protrusion 142. The seating stepped portion 1321 and the stopper stepped portion 1421 may be disposed to face each other in a longitudinal direction of the backup cylinder body 110.

Because the second spring 155 is surrounded by the pedal simulator piston extension 132, a maximum outer diameter portion of the pedal simulator piston extension 132 may be positioned closer to the inner wall of the backup cylinder body 110 than is a maximum outer diameter portion of the second spring 155.

Since the second spring 155 is disposed inside, rather than outside, the pedal simulator piston 130, not only an inner diameter of the backup cylinder body 110 but also an outer diameter thereof may be reduced. As a result, the overall size of the brake system for vehicles may be reduced, thereby enabling weight reduction.

Referring to FIGS. 1, 2, and 4 to 6, the brake system 1 for vehicles according to an embodiment of the present disclosure may include a plurality of seal cups installed on the inner wall of the backup cylinder body 110, and a grease pocket 185. The plurality of seal cups may include a first seal cup 181, a second seal cup 182, a third seal cup 183, and a fourth seal cup 184.

The first seal cup 181 and the second seal cup 182 may be respectively located on both sides of a first port 111 connected to the first backup flow path 15. The first backup flow path 15 may be connected at an end thereof to the first storage portion 11 and at a remaining end thereof to the first port 111. Based on the first port 111, the first seal cup 181 may be located on a side toward the pedal 70, and the second seal cup 182 may be located on a side opposite to the pedal 70, that is, a side toward the stopper 140.

The first seal cup 181 and the second seal cup 182 may be in contact with the backup piston 120. Accordingly, the first seal cup 181 may prevent brake fluid in the first backup chamber 160 from leaking to the outside, and the second seal cup 182 may contribute to generating brake fluid pressure in the first backup chamber 160.

The first seal cup 181 may be spaced apart from the first port 111 toward the pedal 70, and the second seal cup 182 may be spaced apart from the first port 111 toward the stopper 140.

The grease pocket 185 may be located to be spaced apart from the first seal cup 181 toward the pedal 70. Accordingly, the second seal cup 182, the first port 111, the first seal cup 181, and the grease pocket 185 are sequentially positioned in order of increasing proximity to the pedal 70.

The grease pocket 185 may be formed in a recessed groove shape so that grease can be filled therein. The grease pocket 185 may be formed in a circumferential direction along the inner wall of the backup cylinder body 110.

In the case where grease is applied to the grease pocket 185, the grease filled in the grease pocket 185 may form a lubricating film on an outer circumferential surface of the backup piston 120 during assembly or operation of the backup piston 120. Accordingly, when the backup piston 120 passes through the first seal cup 181, dry friction between the backup piston 120 and the first seal cup 181 may be suppressed from occurring.

The grease pocket 185 may be continuously formed in the circumferential direction along the inner wall of the backup cylinder body 110. Accordingly, a lubricating film may be uniformly formed along the outer circumferential surface of the backup piston 120.

Because wet friction occurs between the backup piston 120 and the first seal cup 181 due to the grease provided through the grease pocket 185, frictional noise caused by contact between the backup piston 120 and the first seal cup 181 during pressing and releasing operations of the pedal 70 may be reduced, and a sense of inconsistency in pedal feel may be mitigated.

The first seal cup 181 may have a cross-sectional shape that is approximately a C-shape, a V-shape, or a U-shape.

The first seal cup 181 may include a filling groove 181a in an inner surface that comes into contact with the backup piston 120, the filling groove 181a being capable of being filled with grease.

Grease filled in the grease pocket 185 may be supplied to the backup piston 120 when the backup piston 120 passes through the grease pocket 185 during the assembly or operation of the backup piston 120. Accordingly, when the backup piston 120, with grease applied to the outer circumferential surface thereof, reaches the first seal cup 181, the grease on the outer circumferential surface of the backup piston 120 may flow into the filling groove 181a of the first seal cup 181.

The grease filled in the grease pocket 185 may be provided to the filling groove 181a of the first seal cup 181 by movement of the backup piston 120, and the grease provided in the aforementioned manner may further suppress dry friction from occurring between the backup piston 120 and the first seal cup 181.

The filling groove 181a may be formed in the circumferential direction in the inner surface of the first seal cup 181, and may be continuously formed in a complete circular shape. Accordingly, a lubricating film may be uniformly formed along the outer circumferential surface of the backup piston 120.

Because wet friction occurs between the backup piston 120 and the first seal cup 181 due to the grease introduced into the filling groove 181a of the first seal cup 181, frictional noise caused by contact between the backup piston 120 and the first seal cup 181 during operation of the pedal 70 may be reduced, and a sense of inconsistency in pedal feel may be mitigated.

A plurality of filling grooves 181a may be formed in a circumferential direction in the inner surface of the first seal cup 181. Because the grease introduced into the first seal cup 181 can be retained in a sufficient amount by the plurality of filling grooves 181a, the lubricating film formed on the backup piston 120 may be maintained for an extended period of time.

The plurality of filling grooves 181a may be arranged at regular intervals in the circumferential direction in the inner surface of the first seal cup 181. Since the filling grooves 181a are arranged at regular intervals, the grease can be uniformly applied to the backup piston 120 without being concentrated in a specific region.

The third seal cup 183 and the fourth seal cup 184 may be respectively located on both sides of a second port 116 connected to the second backup flow path 16. Based on the second port 116, the third seal cup 183 may be located on a side toward the pedal 70, and the fourth seal cup 184 may be disposed on a side opposite to the pedal 70, that is, a side toward the stopper 140.

The third seal cup 183 and the fourth seal cup 184 may be in contact with the pedal simulator piston 130. Accordingly, the third seal cup 183 may contribute to sealing of the first backup chamber 160 and to generating brake fluid pressure in the first backup chamber 160. The fourth seal cup 184 may contribute to generating brake fluid pressure in the second backup chamber 165.

The backup cylinder body 110 may include a third port 112 that connects the first flow path 50 to the first backup chamber 160, and a fourth port 117 that connects the fifth backup flow path 19 to the second backup chamber 165.

Referring to FIGS. 1, 2, 7, and 8, the brake system 1 for vehicles according to an embodiment of the present disclosure may include a ball head component 80 and the operating rod 90.

The ball head component 80 may be connected to the pedal 70, and may include a socket depression 85. The ball head component 80 may be directly or indirectly connected to the pedal 70.

The operating rod 90 may be inserted into the socket depression 85, and may be coupled to the ball head component 80. When the driver depresses the pedal 70, the operating rod 90 connected to the ball head component 80 may operate in conjunction with the depression of the pedal 70 to press the backup piston 120. The pressed backup piston 120 may move forward (to the left based on FIG. 2), thus pressurizing the brake fluid in the first backup chamber 160.

When an external force applied to the pedal 70 is removed, the backup piston 120 may return to an original position thereof by a restoring force provided through the first spring 150, the second spring 155, and the damper 170, and the operating rod 90 and the ball head component 80 may also return to original positions thereof.

The ball head component 80 may include a ball head 81 and a socket 82.

The ball head 81 may be directly or indirectly coupled to the pedal 70. The socket 82 may be coupled to the ball head 81, and may include a socket depression 85 into which the operating rod 90 can be inserted. The socket 82 may be integrally formed with the ball head 81.

The operating rod 90 may include a rod body 91 and a rod protrusion 92.

The rod body 91 may be coupled to the backup piton 120. The rod body 91 may be inserted into the backup piston 120, and may press the backup piston 120 when the pedal 70 is pressed.

The rod protrusion 92 is coupled to the rod body 91, and protrudes toward a side opposite to the backup piston 120, that is, toward the pedal 70. The rod protrusion 92 may be inserted into the socket depression 85.

The operating rod 90 may include a rod stepped portion 93. An outer diameter of the rod protrusion 92 may be smaller than an outer diameter of the rod body 91 such that the rod stepped portion 93 is provided at a connection portion between the rod body 91 and the rod protrusion 92.

A depth from an end 83 of the socket 82 to a bottom surface 85a of the socket depression 85 may be greater than a length of the rod protrusion 92. The length of the rod protrusion 92 may correspond to a distance from the rod stepped portion 93 to a front end of the rod protrusion 92.

The rod stepped portion 93 may function as a positioning surface when the operating rod 90 is inserted into the socket depression 85.

During coupling of the ball head component 80 and the operating rod 90, the rod protrusion 92 may be inserted into the socket depression 85 until the rod stepped portion 93 comes into contact with the end 83 of the socket 82.

When the rod stepped portion 93 comes into contact with the end 83 of the socket 82, further insertion of the rod protrusion 92 into the socket depression 85 is blocked. In other words, when the end 83 of the socket 82 contacts the rod stepped portion 93, a position of the ball head component 80 on the operating rod 90 is fixed. Through the aforementioned process, a worker may recognize that the operating rod 90 has been completely coupled to the ball head component 80.

In the case where the operating rod 90 is inserted into the socket depression 85 and the coupling with the ball head component 80 is completed, a front end of the operating rod 90, specifically the front end of the rod protrusion 92 (a right end based on FIG. 7), may be spaced apart from the bottom surface 85a of the socket depression 85 by a distance d.

Because the bottom surface 85a of the socket depression 85 and the front end of the operating rod 90 are spaced apart from each other, the difficulty of machining the socket depression 85 including the bottom surface 85a may be reduced.

The bottom surface 85a of the socket depression 85 is a region having a relatively high machining difficulty due to the size and shape thereof. However, since the bottom surface 85a of the socket depression 85 is spaced apart from the front end of the operating rod 90, machinability of the bottom surface 85a of the socket depression 85 can be improved, and machining deviations of the bottom surface 85a of the socket depression 85 does not affect the coupling between the ball head component 80 and the operating rod 90.

Accordingly, by regulating the dimensions of the ball head component 80 and the operating rod 90, deviation in the length from the backup master cylinder unit 100 to the ball head component 80, to which the pedal 70 is mounted, can be reduced, thereby minimizing dimensional variation.

The rod protrusion 92 and the socket depression 85 may be threadedly coupled to each other. Threads 84 and 94 may be respectively formed on an outer surface of the rod protrusion 92 and an inner surface of the socket depression 85, thus enabling the threaded coupling between the rod protrusion 92 and the socket depression 85.

Referring to FIGS. 1, 2, 9, and 10, the brake system 1 for vehicles according to an embodiment of the present disclosure may include a bracket housing 200 and a piston guard 210.

The bracket housing 200 encloses the backup piston 120. The piston guard 210 is mounted to the bracket housing 200, and extends toward the operating rod 90. The piston guard 210 may come into contact with the operating rod 90 and prevent foreign substances from entering the backup piston 120.

The piston guard 210 may include a guard mounting portion 211 and a guard blocking portion 215. The piston guard 210 may include an elastically deformable material. In the present embodiment, the piston guard 210 may include a rubber material.

The guard mounting portion 211 is mounted to the bracket housing 200. The bracket housing 200 is formed to be open at one side thereof to allow movement of the operating rod 90. The guard mounting portion 211 may include a peripheral mounting portion 213 and a peripheral extension portion 212.

The peripheral mounting portion 213 may be mounted to enclose a periphery of the bracket housing 200 at the open end side of the bracket housing 200. A groove may be formed in an outer circumferential surface of the open end of the bracket housing 200, and the peripheral mounting portion 213 may be fitted into the groove of the bracket housing 200.

The peripheral extension portion 212 extends from the peripheral mounting portion 213 toward the pedal 70, and is formed to enclose the operating rod 90.

A connection groove 214 may be provided in an inner surface of the guard mounting portion 211 where the peripheral mounting portion 213 and the peripheral extension portion 212 are connected, that is, at an inner side of a connection region between the peripheral mounting portion 213 and the peripheral extension portion 212.

Due to the connection groove 214, a thickness of the connection region between the peripheral mounting portion 213 and the peripheral extension portion 212 may be reduced compared to those of the peripheral mounting portion 213 and the peripheral extension portion 212.

During operation of the pedal 70, the operating rod 90 may tilt with respect to the backup piston 120 within a predetermined angle range. Because the guard mounting portion 211 has the connection groove 214, which has a smaller thickness than other portions and is formed in the connection region between the peripheral mounting portion 213 and the peripheral extension portion 212, vertical movement of the guard blocking portion 215 during tilting of the operating rod 90 can be facilitated.

Accordingly, because the vertical movement of the guard blocking portion 215 can be smoothly performed during tilting of the operating rod 90, the operating rod 90 and the guard blocking portion 215 can be prevented from being spaced apart from each other, thereby blocking introduction of foreign substances around the entire circumference of the operating rod 90.

The connection groove 214 may be continuously formed in a circumferential direction on the inner surface of the guard mounting portion 211. Accordingly, the guard blocking portion 215 may be allowed to move in any direction without being limited to a specific direction.

The guard blocking portion 215 is integrally formed with the guard mounting portion 211 and extends toward the operating rod 90 so as to come into contact with the operating rod 90.

The guard blocking portion 215 may enclose the circumference of the operating rod 90 and come into contact with the operating rod 90, thus preventing foreign substances, including dust, from entering the backup piston 120 during movement of the operating rod 90.

The guard blocking portion 215 may include connection blocking portions 216, 217, and 218, and a contact blocking portion 219

The connection blocking portions 216, 217, and 218 may include a first connection blocking portion 216 connected to the guard mounting portion 211, a second connection blocking portion 217 that is connected to the first connection blocking portion 216 and has a thickness greater than that of the first connection blocking portion 216, and a third connection blocking portion 218 that is connected to the second connection blocking portion 217 and extends toward the operating rod 90 from the second connection blocking portion 217.

An angle formed between the guard mounting portion 211 and the guard blocking portion 215 may be an acute angle. In the present embodiment, the guard mounting portion 211 and the first connection blocking portion 216 are oriented at an acute angle therebetween.

Because the guard blocking portion 215 forms an acute angle (θ) rather than a right angle with respect to the guard mounting portion 211, deformation of the guard blocking portion 215 during tilting of the operating rod 90 can be more easily achieved. Accordingly, sliding movement of the operating rod 90 can be made smoother, and because the guard blocking portion 215 remains in constant contact with the operating rod 90, foreign substances including dust can be prevented from entering the backup piston 120 during movement of the operating rod 90.

The contact blocking portion 219 is in contact with the operating rod 90. The contact blocking portion 219 may extend from the third connection blocking portion 218, and may have a length greater than a distance from an end of the third connection blocking portion 218 to the operating rod 90. Accordingly, the contact blocking portion 219 can remain in close contact with the operating rod 90 even during tilting of the operating rod 90.

Each of the second connection blocking portion 217 and the third connection blocking portion 218 may be thicker than the contact blocking portion 219. Accordingly, the second connection blocking portion 217 and the third connection blocking portion 218 may stably support the contact blocking portion 219, and the contact blocking portion 219 may be more easily elastically deformed. As a result, the contact blocking portion 219 may provide a uniform contact pressure along the circumference of the operating rod 90, and sliding movement of the operating rod 90 may be made smoother.

The third connection blocking portion 218 may be oriented perpendicular to the operating rod 90. Accordingly, the third connection blocking portion 218 may stably support the contact blocking portion 219, and elastic deformation upon contact with the operating rod 90 may occur to a greater extent in the contact blocking portion 219 than in the third connection blocking portion 218.

According to the present embodiment, by applying the slide-type piston guard 210, close contact with the operating rod 90 may be maintained even when the operating rod 90 tilts due to operation or swinging of the pedal 70, thereby preventing foreign substances from entering the backup piston 120. In addition, even when the pedal 70 is designed to have a relatively long full stroke, design constraints may not be imposed, thereby improving design flexibility. Furthermore, the slide-type piston guard 210, in comparison with a bellows-type piston guard, can alleviate constraints related to the fixed installation length and full stroke, and can achieve a reduction in material costs through simplification in shape and reduction in weight.

Referring to FIGS. 1, 2, and 11 to 17, the damper 170 may be located between the stopper 140 and the pedal simulator piston 130. The damper 170 may be changed in shape when the pedal simulator piston 130 is moved toward the stopper 140 by pressing of the pedal 70.

As the damper 170 is changed in shape by an operation of pressing the pedal 70, the brake system 1 for vehicles may provide a reaction force to the driver. When the pedal 70 is released from pressing, the damper 170 may provide a restoring force to return the pedal simulator piston 130 and other related components to original positions thereof.

In the present embodiment, only one damper 170 may be provided in the backup master cylinder unit 100. Accordingly, assembly workload and material costs of the backup master cylinder unit 100 may be reduced, and design flexibility may be improved.

The damper 170 may include a material expandable outward when compressed by pressing of the pedal simulator piston 130. The damper 170 may be changed in shape such that a length thereof decreases and a radial width thereof, that is, an outer diameter thereof, increases when compressed by pressing of the pedal simulator piston 130. The damper 170 may include a rubber material.

The damper 170 may include a damper body 171 and a damper protrusion 176.

The damper body 171 may be formed in a hollow columnar shape. A through-hole 179 extending in a longitudinal direction of the damper body 171 may be provided in a central portion of the damper body 171. Because the damper body 171 is formed in a columnar shape, durability may be improved. The damper body 171 may be formed in a substantially cylindrical shape.

The damper body 171 may include a first surface 173a facing the stopper 140, and a second surface 173b facing a closed end (a right end based on FIG. 2) of the pedal simulator piston 130. The damper body 171 may have a columnar shape extending from the first surface 173a toward the second surface 173b. A longitudinal direction of the damper body 171 may be the same as a longitudinal direction of the backup cylinder body 110.

The damper protrusion 176 may be formed to protrude from at least one of the first surface 173a or the second surface 173b of the damper body 171. In other words, the damper protrusion 176 may be formed only on the first surface 173a, only on the second surface 173b, or on both the first surface 173a and the second surface 173b.

A plurality of damper protrusions 176 may be arranged at regular rotational intervals on either the first surface 173a or the second surface 173b of the damper body 171. In the present embodiment, three damper protrusions 176 are arranged at 120-degree rotational intervals; however, the arrangement is not limited thereto and, for example, two damper protrusions may be arranged at 180-degree intervals or four damper protrusions may be arranged at 90-degree intervals. Protrusion heights of the plurality of damper protrusions 176 may be the same.

Because the damper 170 includes the damper protrusion 176 in addition to the damper body 171, an inflection point of the pedal reaction force may be controlled in a greater variety of ways.

The damper protrusion 176 may be formed in a shape in which a cross-sectional area decreases in a direction away from the damper body 171. In the present embodiment, the damper protrusion 176 is formed in a substantially conical shape.

Because the damper protrusion 176 has a smaller cross-sectional area toward a front end thereof than at a portion connected to the damper body 171, a force required to compressively deform the damper protrusion 176 increases as the deformation progresses from an initial stage.

The damper body 171 may include a plurality of damper ribs 172 protruding outward from an outer circumferential surface 171a. The plurality of damper ribs 172 may be arranged to be spaced apart from each other.

The plurality of damper ribs 172 may be arranged on the damper body 171 at regular rotational intervals. In the present embodiment, six damper ribs 172 are arranged at 60-degree rotational intervals; however, the arrangement is not limited thereto, and, for example, three damper ribs 172 may be arranged at 120-degree intervals or four damper ribs 172 may be arranged at 90-degree intervals. Protrusion heights of the plurality of damper ribs 172 may be the same.

Because the damper 170 may include the damper ribs 172 in addition to the columnar damper body 171, the inflection point of the pedal reaction force may be controlled in more various ways.

Each of the damper ribs 172 may include a protruding rib portion 172a and inclined rib portions 172b.

The protruding rib portion 172a may be positioned in a longitudinal central portion on the outer circumferential surface 171a of the damper body 171, and the inclined rib portions 172b may be respectively connected to opposite longitudinal ends of the protruding rib portion 172a.

Each of the inclined rib portions 172b may be formed such that a height thereof protruding from the outer circumferential surface 171a of the damper body 171 decreases in a direction away from the protruding rib portion 172a. The inclined rib portion 172b may include an inclined surface, which may have a planar shape or a gently curved shape with curvature.

Because the damper rib 172 of the damper 170 is divided into the protruding rib portion 172a and the inclined rib portions 172b, the inflection point of the pedal reaction force may be controlled in more various ways.

Deformation states of the damper 170 according to an embodiment of the present disclosure due to the stopper 140 and the pedal simulator piston 130 will be described below with reference to FIGS. 16 and 17.

As the driver depresses the pedal 70, the operating rod 90 and the backup piston 120 may be moved forward (to the left based on FIG. 2) by pressing of the pedal 70, and the pedal simulator piston 130 may also be moved forward. Accordingly, the damper 170, which is located between the stopper 140 and the pedal simulator piston 130, starts to be pressed by the pedal simulator piston 130.

In state A, the damper protrusion 176 formed on at least one of the first surface 173a or the second surface 173b of the damper body 171 comes into contact with a corresponding one of the stopper 140 or the pedal simulator piston 130. In the present embodiment, the damper protrusions 176 formed on both the first surface 173a and the second surface 173b of the damper body 171 come into contact with the stopper 140 and the pedal simulator piston 130, respectively.

In state B, the damper protrusions 176 are considerably compressed by the stopper 140 and the pedal simulator piston 130. Furthermore, portions of the first surface 173a and the second surface 173b of the damper body 171, where the damper protrusions 176 are not formed, come into contact with the stopper 140 and the pedal simulator piston 130.

In state C, substantially the entire areas of the portions of the first surface 173a and the second surface 173b, where the damper protrusions 176 are not formed, comes into contact with the stopper 140 and the pedal simulator piston 130. Furthermore, the protruding rib portion 172a of each of the damper ribs 172 comes into contact with the inner diameter portion of the pedal simulator piston 130.

In state D, substantially the entire area of the protruding rib portion 172a comes into contact with the inner diameter portion of the pedal simulator piston 130. Furthermore, the outer circumferential surface 171a of the damper body 171, where the protruding rib portions 172a are not formed, comes into contact with the inner diameter portion of the pedal simulator piston 130.

In state E, where the pedal 70 is in a full-stroke state, substantially the entire area of the outer circumferential surface 171a of the damper body 171, where the protruding rib portions 172a are not formed, comes into contact with the inner diameter portion of the pedal simulator piston 130.

During the transition from state A to state E, the length of the damper 170 in a longitudinal direction gradually decreases.

The labels A to E in FIG. 16 schematically illustrate the shape of the damper 170 in states A to E, and the labels A to E in FIG. 17 represent the correlation between displacement and force in states A to E. In FIG. 17, the displacement represents the stroke of the pedal 70 by the driver, and the force represents the reaction force of the pedal 70.

Because the damper 170 includes, in addition to the cylindrical damper body 171, the damper protrusion 176 and the damper rib 172, the inflection point of the pedal reaction force may be controlled at a plurality of points, such as labels A to E, and a gradient of the pedal reaction force may be adjusted to be gentle so that the pedal feel can be improved.

According to the present disclosure, it is possible to prevent foreign substances from entering a backup piston.

According to the present disclosure, upward and downward movement of a piston guard can be facilitated when the operating rod tilts, thereby improving sealing performance and sliding movability of the operating rod.

According to the present disclosure, even when a pedal is designed to have a relatively long full stroke, design constraints may not be imposed, thereby improving design flexibility. Furthermore, a slide-type piston guard according to the present disclosure, in comparison with a conventional bellows-type piston guard, can alleviate constraints related to a fixed installation length and full stroke, and can achieve a reduction in material costs through simplification in shape and reduction in weight.

According to the present disclosure, it is possible to suppress dry friction between the backup piston and a seal cup. Accordingly, occurrence of stick-slip and sliding noise can be suppressed, and an inconsistent pedal feel can be reduced.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A brake system for vehicles, comprising:
a pedal configured to receive a pressing input from a user;
a ball head connected to the pedal;
an operating rod coupled to the ball head, and configured to move upon depression of the pedal;
a backup cylinder body;
a backup piston configured to move inside the backup cylinder body according to movement of the operating rod;
a bracket housing enclosing the backup piston; and
a piston guard mounted to the bracket housing, and extending toward the operating rod, the piston guard contacting the operating rod so that foreign substances are prevented from entering the backup piston.

2. The brake system of claim 1, wherein the piston guard comprises:
a guard mounting portion mounted to the bracket housing; and
a guard blocking portion integrally formed with the guard mounting portion, and extending toward the operating rod, the guard blocking portion contacting the operating rod.

3. The brake system of claim 2, wherein the guard mounting portion comprises:
a peripheral mounting portion enclosing the bracket housing; and
a peripheral extension portion extending from the peripheral mounting portion toward the pedal, and enclosing the operating rod,
wherein a connection groove is formed in an inner surface of the guard mounting portion where the peripheral mounting portion and the peripheral extension portion are connected.

4. The brake system of claim 3, wherein the connection groove is continuously formed in a circumferential direction on the inner surface of the guard mounting portion.

5. The brake system of claim 2, wherein an angle formed between the guard mounting portion and the guard blocking portion is an acute angle.

6. The brake system of claim 2, wherein the guard blocking portion comprises:
a connection blocking portion coupled to the guard mounting portion; and
a contact blocking portion extending from the connection blocking portion, and having a length greater than a distance from an end of the connection blocking portion to the operating rod, the contact blocking portion contacting the operating rod.

7. The brake system of claim 6, wherein a thickness of the connection blocking portion is greater than a thickness of the contact blocking portion.

8. The brake system of claim 1, wherein the piston guard includes a rubber material.

9. A brake system for vehicles, comprising:
a backup cylinder body;
a backup piston located in the backup cylinder body, and configured to be movable upon depression of a pedal;
a pedal simulator piston movably disposed in the backup cylinder body, and spaced apart from the backup piston;
a first backup chamber defined in the backup cylinder body between the backup piston and the pedal simulator piston, and configured to store brake fluid;
a stopper disposed in the backup cylinder body, and configured to restrict movement of the pedal simulator piston;
a second backup chamber defined in the backup cylinder body between the stopper and the pedal simulator piston, and spaced apart from the first backup chamber, the second backup chamber being configured to store brake fluid;
a first seal cup disposed on an inner wall of the backup cylinder body, and configured to contact the backup piston, the first seal cup being spaced apart from a first port connected to a reservoir toward the pedal; and
a grease pocket spaced apart from the first seal cup toward the pedal, the grease pocket being formed in a recessed groove shape and configured to be filled with grease.

10. The brake system of claim 9, wherein the grease pocket is formed in a circumferential direction along the inner wall of the backup cylinder body.

11. The brake system of claim 9, wherein the first seal cup includes a filling groove in an inner surface thereof that comes into contact with the backup piston, the filling groove being configured to be filled with grease.

12. The brake system of claim 11, wherein the filling groove is formed along a circumferential direction in the inner surface of the first seal cup.

13. The brake system of claim 12, wherein the filling groove comprises a plurality of filling grooves formed in the inner surface of the first seal cup.

14. The brake system of claim 13, wherein the plurality of filling grooves are arranged at regular intervals on the inner surface of the first seal cup.
